(19) United States
(12) Patent Application Publication
(10) Pub. No.: US 2003/0211375 A1
(43) Pub. Date: Nov. 13, 2003

(54) Solid oxide fuel cell stack assembly for direct injection of carbonaceous fuels

(75) Inventor: Robert C. Ruhl, Cleveland Heights, OH (US)

Correspondence Address: D. Peter Hochberg Co., L.P.A., The Baker Building - 6th Floor, 1940 East 6th Street, Cleveland, OH, 44114-2294, US

(73) Assignee: Technology Management, Inc.

(21) Appl. No.: 10/141,281

(22) Filed: May 8, 2002

(51) Int. Cl. H01M 8/12; H01M 4/94

(52) U.S. Cl. 429/30; 429/35; 429/44; 204/265

(57) ABSTRACT

An electrochemical system adapted to facilitate the direct injection of a variety of carbonaceous fuels or to perform steam electrolysis. The electrochemical system comprises either of three operating modes: a single stage fuel cell embodiment, a two stage fuel cell embodiment, and an electrolyzer embodiment. The system further includes a feed tube having appropriate seals introducing carbonaceous fuel or water directly into a fuel mixing chamber inside the electrochemical cell stack. One or more exit conduits allow the gas mixture to exit from the fuel mixing chamber.

### FIELD OF THE INVENTION

The present invention relates generally to electrochemical systems, such as solid-oxide electrolyte fuel cells and fuel cell assemblies for directly converting chemical energy into electricity. More particularly, the present invention relates to a modified fuel cell system adapted to facilitate the direct injection of carbonaceous fuels.

### DESCRIPTION OF THE PRIOR ART

Planar, or flat, solid oxide fuel cell stacks are well known in the industry. Generally, a fuel cell is an electrochemical device that combines a fuel, such as hydrogen, with oxygen to produce electric power, heat and water. The solid oxide fuel cell consists of an anode, a cathode and an electrolyte. The anode and cathode are porous, thus allowing gases to pass through them. The electrolyte, located between the anode and cathode, is permeable only to oxygen ions as they pass from the cathode to the anode. The passing of the oxygen ions through the electrolyte creates an excess of electrons on the anode side to complete an electrical circuit through an external load to the cathode side, which is electron deficient.

A solid oxide fuel cell is very advantageous over conventional power generation systems. It is known in the industry that such devices are capable of delivering electric power with greater efficiency and lower emissions as compared to engine-generators.

Known planar solid oxide fuel cell stacks utilize a forced flow of gases through their electrodes. Furthermore, they employ fuel and air flow designs so that all, or at least many, of the cells are fed the same fuel and air compositions. The stacks are capable of producing good, but not optimal efficiencies. Furthermore, the stacks tend to exhibit significant local flow differences amongst cells and within cells. This can lead to increased stack performance degradation and reduced stack efficiency. Further still, the stacks may require significant pressure drops, and therefore compression power, for the flowing gases.

Known fuel cell systems for operation on hydrocarbon fuels require processing of the fuel prior to its introduction into a fuel cell stack or bundle. Such processing involves adding water, steam, spent fuel mixture, and/or air to the fuel and passing the resulting mixture over a hot catalyst bed. These fuel processors are vulnerable to solid carbon formation problems, necessitating either frequent cleaning or else operation with fairly high oxygen/carbon ratios which can reduce possible fuel cell efficiency. In addition, the catalysts used often cannot tolerate significant sulfur levels and thus require the fuel to be previously desulfurized.

It is known that the ability to directly and continuously feed carbonaceous fuels (without prior addition of water or oxygen) to a high temperature fuel cell has significant and distinct advantages. For example, such a system significantly improves the possible efficiency of converting chemical energy to electrical energy. Additionally, such a system eliminates much of the costly auxiliary equipment needed in conventional complete fuel cell systems, such as fuel processors, some heat exchangers, water systems and the like. It is expected that such a system will facilitate the ability to use fuels which are normally difficult to employ with conventional fuel cell systems in a practical manner, such as diesel fuel and distillate heating oils. The present invention reduces the size, weight, complexity and cost of employing a complete fuel cell system

U.S. Pat. No. 5,366,819 (Hartvigsen et al.) and U.S. Pat. No. 5,763,114 (Khandkar et al) disclose a fuel steam reformer located inside a furnace, which also houses stacks of solid oxide fuel cells. The fuel cell stacks furnish the required heat input to the reformer. The reformer contains a hot steam reforming catalyst bed which converts hydrocarbon fuel (desulfurized natural gas) and water into a hot fuel gas mixture suitable for feeding into the fuel cell stacks.

U.S. Pat. No. 5,741,605 (Gillett et al.) discloses the use of fuel reformers which use steam-laden spent fuel gas mixed with incoming hydrocarbon fuel and a reforming catalyst bed to produce a hot fuel gas mixture. Like the above patents, this configuration is also thermally integrated with fuel cell stacks and is external to the fuel cell assemblies themselves.

Thus, there is an unsatisfied need to have a complete fuel cell system adapted for the direct injection of carbonaceous fuels into fuel cell stacks without operating problems resulting from solid carbon formation.

### SUMMARY OF THE INVENTION

The present invention is an electrochemical system adapted to allow for the direct injection of carbonaceous fuels for employment therein. The present invention can be employed as either a single stage embodiment or as a two stage embodiment. The fuel cell stack is operated with an electrochemical fuel utilization that is high enough, such as at least 30%, to supply enough oxygen to the fuel mixture in order to prevent significant amounts of carbon to accumulate in the fuel cell system's fuel chamber.

It is an object of the present invention to provide an electrochemical system adapted to facilitate the direct injection of carbonaceous fuels.

It is another object of the present invention to provide an electrochemical system adapted to allow for the direct injection of carbonaceous fuels having a single stage embodiment and a two stage embodiment.

It is yet another object of the present invention to provide an electrochemical system whereby the accumulation of carbon within the system is controlled to permit continuous power generation for thousands of hours without carbon removal being required.

It is still yet another object of the present invention to permit steam electrolyzer operation using an unmixed steam feed.

### BRIEF DESCRIPTION OF THE DRAWINGS

FIG. 1 is a cross section of two adjacent, identical cells, contained in a stack of such cells, of a single stage configuration of the present invention.

FIG. 2 is a cross section of two adjacent, identical cells, contained in a stack of such cells, of a two stage configuration of the present invention.

FIG. 3 is a cross section of two adjacent, identical cells, contained in a stack of such cells, of a steam electrolyzer of the present invention.

FIG. 4 is a cross-section of an alternative embodiment of the present invention as shown in FIG. 1.

### DETAILED DESCRIPTION OF THE PREFERRED EMBODIMENTS

The present invention is now described with reference to the drawings, wherein like reference numerals are used to refer to like elements throughout. In the following description, for purposes of explanation, numerous specific details are set forth in order to provide a thorough understanding of the present invention. It will be evident, however, to one skilled in the art that the present invention may be practiced without these specific details.

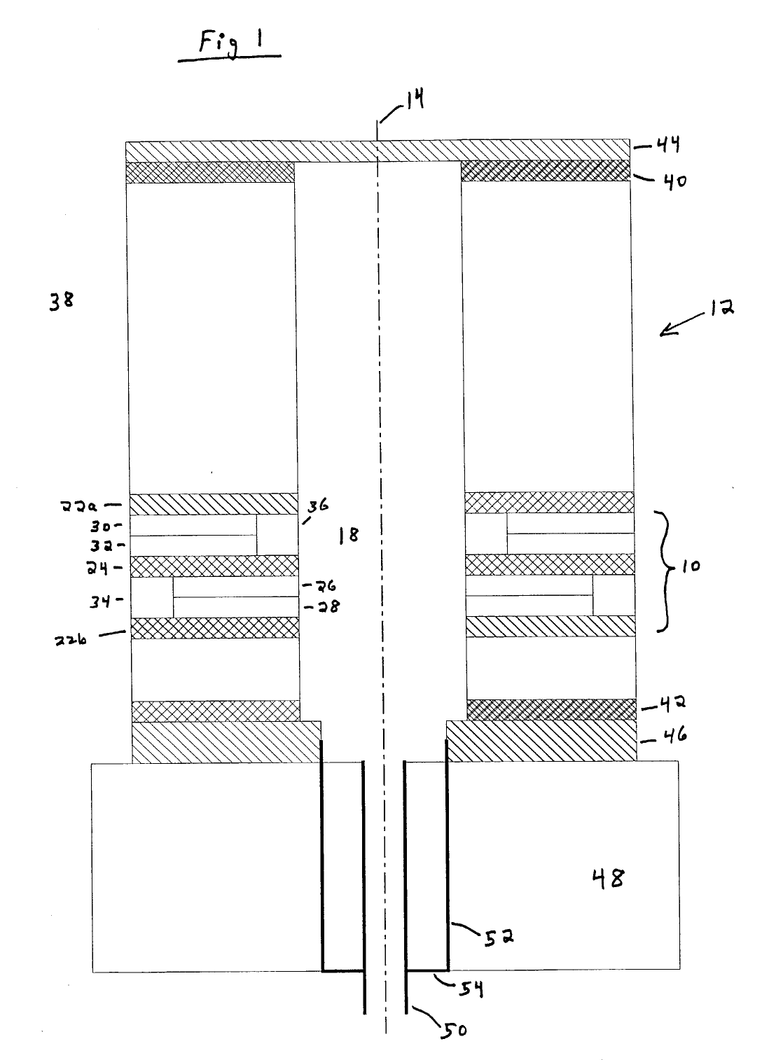

Referring now to FIG. 1, a cross section showing a single hollow circular cell 10 contained in a stack 12 of like cells of the single stage configuration system of the present invention is shown. It is also noted that FIG. 1 shows two adjacent cells having like elements. For purposes of explanation, stack 12 is referred to as having just one cell 10, however any numbers of cells 10 may be employed in stack 12. A cylinder centerline 14 is also shown. Cells 10 surround a fuel mixing chamber 18. An oxidizer chamber 38 surrounds stack 12 and provides a source of oxygen to the stack.

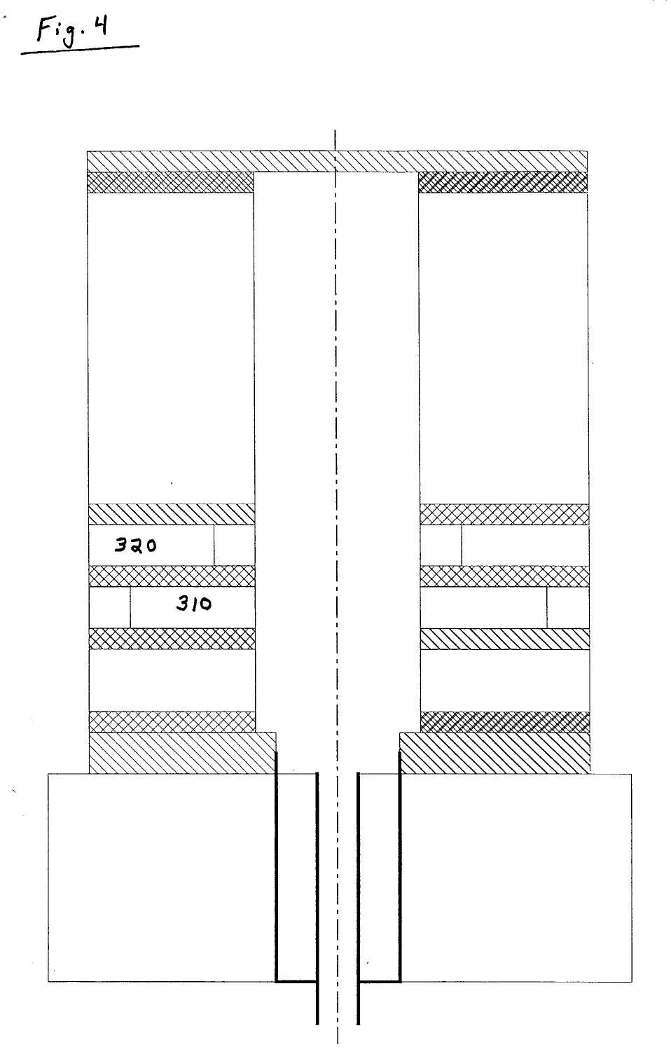

Each cell 10 is separated from and electrically connected to adjacent cells by an electronically conductive separator disc 22a, b. Each cell 10 contains only one separator disc 22a, the second separator disc 22b being a separator of an adjacent cell. Inside each cell 10 is a solid oxide electrolyte disc 24. A fuel electrode 26 abuts electrolyte disc 24 directly below electrolyte disc 24. Fuel electrode 26 may advantageously be a sulfur tolerant fuel electrode, such as that described in U.S. Pat. No. 6,238,816 B1, the details of which are incorporated by reference herein. A fuel diffusion layer 28 is positioned between the fuel electrode 26 and separator 22b. An oxygen electrode 32 abuts electrolyte disc 24 directly above electrolyte disc 24. An oxygen diffusion layer 30 is positioned between the oxygen electrode 32 and separator 22a. Both fuel diffusion layer 28 and oxygen diffusion layer 30 are highly porous and sufficiently thick so as to allow the requisite gases to diffuse through them with only moderate composition gradients. Layers 28 and 30 are also good electrical conductors. It is appreciated that fuel electrode 26 and fuel diffusion layer 28 could alternatively comprise the same material, thereby being a single structure, such as a fuel electrode-diffusion layer 310 (FIG. 4). Fuel electrode-diffusion layer 310 would serve the same purposes of both fuel electrode 26 and fuel diffusion layer 28. Additionally, oxygen diffusion layer 30 and oxygen electrode 32 could be a single structure, such as an oxygen electrode-diffusion layer 320 (FIG. 4).

A fuel electrode annular seal 34 surrounds fuel electrode 26 and fuel diffusion layer 28. Seal 34 extends from separator 22b to electrolyte disc 24. The upper end of seal 34 is substantially flush with electrolyte disc 24. The lower end of seal 34 is substantially flush with separator 22b. An oxygen electrode annular seal 36 is located inside oxygen electrode 32 and oxygen diffusion layer 30. Seal 36 extends from electrolyte disc 24 to separator 22a. The upper end of seal 36 is substantially flush with separator 22a. The lower end of seal 36 is substantially flush with electrolyte disc 24.

Separators 22a and 22b can be made of any material common in the field, such as a high-temperature alloy which forms a thin protective oxide surface layer with good high-temperature electrical conductivity. Electrolyte disc 24 may be of yttria-stabilized zirconia, or any other suitable material. Fuel electrode 26 and fuel diffusion layer 28 can be of, for example, a doped ceria/nickel mixture. Nickel foam may be used for fuel diffusion layer 28 except in cells operating on fuel mixtures with very high oxygen potentials. Oxygen electrode 32 and diffusion layer 30 can be of, for example, strontium-doped lanthanum manganite. Seals 34 and 36 can be made from a suitable glass. A thin layer of ink, such as an ink made from a finely-divided electrode composition, may be applied on each side of separators 22a, b. Ink is applied to improve the electrical contact between the components of cell 10.

Hot oxidizer manifold 38 contains an oxygen bearing gas mixture, which is typically comprised of nitrogen, oxygen, water vapor and carbon dioxide.

An unsealed fuel flow layer 40, 42 is at each end of stack 12. Unsealed fuel flow layers 40, 42 allow partially oxidized fuel gas to continually exit from stack 12. Stack 12 is additionally clamped or situated between a first electrically conductive end plate 44 and a second electrically conductive end plate 46 via a spring-loaded clamping means (not shown) or any other method conventional in the art. A first unsealed fuel flow layer 40, which is substantially annular in form, is directly below and abuts the bottom of first end plate 44. The second unsealed fuel flow layer 42 is directly above and abuts the top of the second end plate 46, both of which are substantially annular in form.

Stack 12 still further includes a thermal insulation 48 at the base of stack 12 and below second end plate 46. A fuel feed tube 50 is introduced into stack 12 through the center of stack 12 at its end having thermal insulation 48, second unsealed fuel flow layer 42 and second end plate 46, and is introduced between thermal insulation 48 and the annular second end plate 46 overlying thermal insulation 48. Fuel feed tube 50 serves as a conduit for the introduction of a carbon-containing fuel, such as natural gas, diesel fuel and distillate oils, directly into the center of stack 12. Fuel feed tube 50 is sealed by welding to second end plate 46 via a sealing tube 52 and disc 54. Thermal insulation 48 is also present in the annulus between tubes 50 and 52.

Thermal insulation 48 can optionally further include additional insulation (not shown) and thermal insulation 48 serves to insulate the heated stack 12 and fuel feed tube 50 during operation. It is noted that fuel electrode 26, fuel diffusion layer 28, oxygen diffusion layer 30, oxygen electrode 32, unsealed fuel flow layer 40, unsealed fuel flow layer 42 and thermal insulation 48 are porous and permit gas to flow through them. The remaining elements in FIG. 1 are substantially impervious.

Referring now to the operation of stack 12 and still referring to FIG. 1, stack 12 is generally preheated by a suitable preheating means (not shown) conventional in the art and preheated to a suitable temperature that is sufficiently hot, such as about 850° C. A gaseous or liquid carbonaceous fuel is introduced into stack 12 via fuel feed tube 50 at a sufficiently high flow rate so that the temperature of the carbonaceous fuel upon exit of stack 12 is low enough to prevent the formation of solid carbon or any other solid deposits to form or be deposited within fuel feed tube 50. A typical maximum fuel feed temperature is about 400° C.; however the temperature is fuel-type dependent. Carbonaceous fuels suitable for use with this invention include natural gas, propane, gasoline, diesel fuel, kerosene, distillate heating oils, and other gaseous and distillate liquid hydrocarbons. Other suitable fuels include biogas, biodiesel, alcohols, and mixtures of gases or liquids containing carbonaceous compounds, including fuels from gasifiers. Generally, the suitable fuels must be essentially free from dissolved salts and particulates and contain limited levels of halogens and sulfur.

Stack 12 is operated with an electrochemical fuel utilization high enough, such as at least 30%, so that enough oxygen is supplied to the fuel mixture in fuel chamber 18, thus preventing a significant carbon accumulation in chamber 18. It is appreciated that the minimum value depends upon the type of fuel used and stack operating temperature. It is also appreciated that carbon deposits between fuel feed tube 50 and sealing tube 52 will typically occur and such deposits are tolerable.

Fuel feed tube 50 has a diameter and a spatial orientation such that a high fuel entry velocity and a sufficient mixing of the gas in fuel chamber 18 is achieved. It is noted that various operating conditions can be obtained by varying the flow of fuel through fuel feed tube 50 and stack current, thereby providing a relatively wide range of stack 12 power outputs and efficiencies.

The partially oxidized fuel mixture exits stack 12 through unsealed fuel flow layers 40 and 42 whereby the partially oxidized fuel mixture encounters an oxidizing gas and is immediately completely oxidized. The best efficiencies are achieved when the electrochemical fuel utilization of stack 12 is close to about 90%. For example, at 900° C, the calculated maximum possible fuel cell efficiency of a single stage configuration on natural gas is over 60%, which is calculated by stack power/natural gas lower heating value.

Hot oxidizer manifold 38 is continually supplied with air preheated by a heat exchange with the exhaust mixture which continually exits hot oxidizer manifold 38. The temperature of stack 12 is maintained at a desired value, such as about between 800° C. and 900° C. and is maintained in this desired range by the combined cooling effects of incoming air, incoming fuel, and the endothermic chemical reactions (principally fuel molecules reacting with H₂O and CO₂ gases) which occur in fuel mixing chamber 18 as well as in the cell layers 26 and 28. These chemical reactions are possibly enhanced by the formation of a persistent cloud of extremely fine solid carbon particles within fuel mixing chamber 18.

It is noted that for purposes of explanation, the present invention is described and shown as being circular, however the system of the present invention may also be employed with electrochemical systems of any shape used in the art, such as polygonal or ovoid. In alternative embodiments, the center of cell 10 can be defined by any number of hollow cavities.

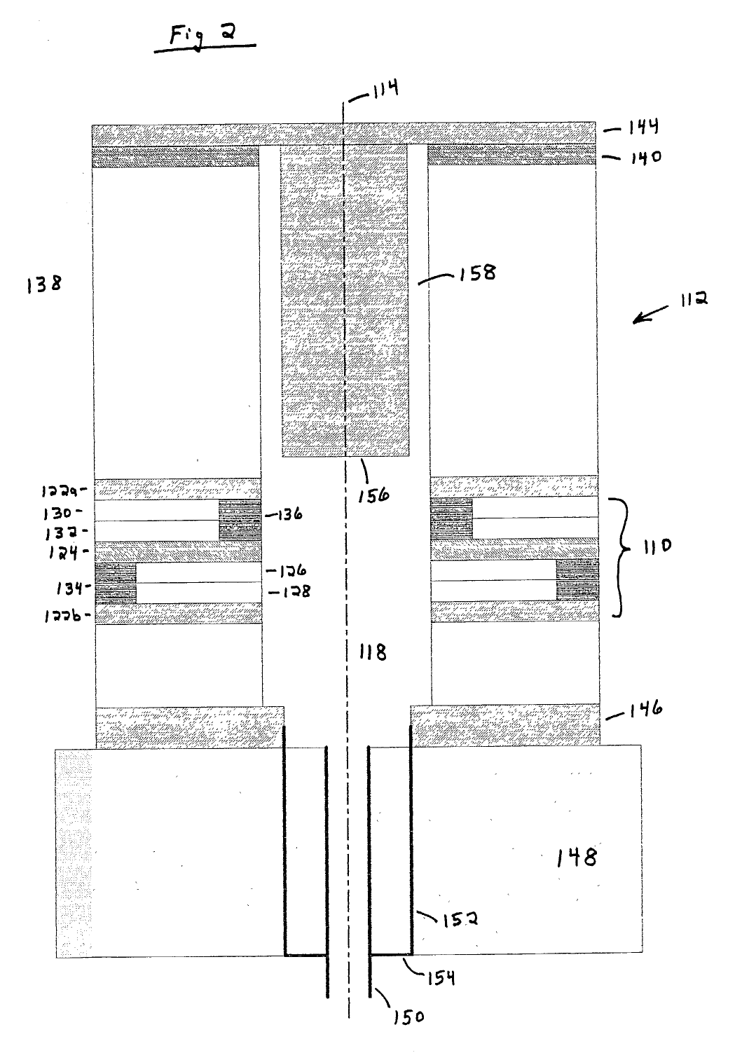

Referring now to FIG. 2, an electrochemical fuel cell stack is shown having a two-stage embodiment of the present invention and is referred to as numeral 112. Stack 112 includes the same components and elements in the same configuration as the single stage configuration as described above, including at least two cells 110, a centerline 114, a fuel mixing chamber 118, separator discs 122a, b, a fuel electrode 126, a fuel diffusion layer 128, a solid oxide electrolyte disc 124, an oxygen diffusion layer 130, an oxygen electrode 132, a fuel electrode annular seal 134, an oxygen electrode annular seal 136, a hot oxidizer manifold 138, an unsealed fuel flow layer 140, end plates 144 and 146, thermal insulation 148, a fuel feed tube 150, a sealing tube 152, and a fuel feed tube sealing disc 154.

Stack 112 differs from stack 12 (FIG. 1) in that stack 112 includes only a single unsealed fuel flow layer 140 at an end of stack 112 and is flush with a first end plate 144 and is at the end of stack 112 that is opposite that of the point of introduction of fuel feed tube 150 into stack 112. Stack 112 further includes a solid cylinder 156 comprised of any heat resistant material conventional in the art. Solid cylinder 156 is located above fuel chamber 118 and is flush with first end plate 144 so that the top of solid cylinder 156 abuts the bottom of first end plate 144.

Cells 110 that directly surround the fuel mixing chamber 118 provide an adequate amount of oxygen to achieve an electrochemical fuel oxidation of at least about 30%, which is the minimum value to prevent carbon accumulation problems, and which depends upon the type of fuel used and operating temperature. The fuel mixture flows through the annular fuel manifold 158, whereby the plurality of cells 110 progressively further oxidize the fuel to a final cumulative electrochemical oxidation value, which can be as high as 100%. It is noted that this may even slightly exceed 100%, with a small percentage of free oxygen present. It is also noted that the cumulative oxidation value depends upon fuel feed rate, fuel type, stack electric current, and the number of cells in the stack 112. The voltage of one or more cells near the exit layer 140 can be used for automatic closed-loop regulation of cumulative fuel electrochemical oxidation. It has been found that a two stage configuration of the present invention can achieve a higher average chemical potential or electromotive force due to the use of progressive oxidation of the fuel mixture as it flows through annular manifold 158, together with the presence of a rich mixture in the fuel mixing chamber 118. It has also been found that the two stage configuration of the present invention can advantageously operate at a higher overall electrochemical fuel utilization than a single stage system. For example, at 900° C., the calculated maximum possible fuel cell efficiency of a two stage configuration of the present embodiment of the present invention on natural gas is over 80%, calculated by the stack power/natural gas lower heating value.

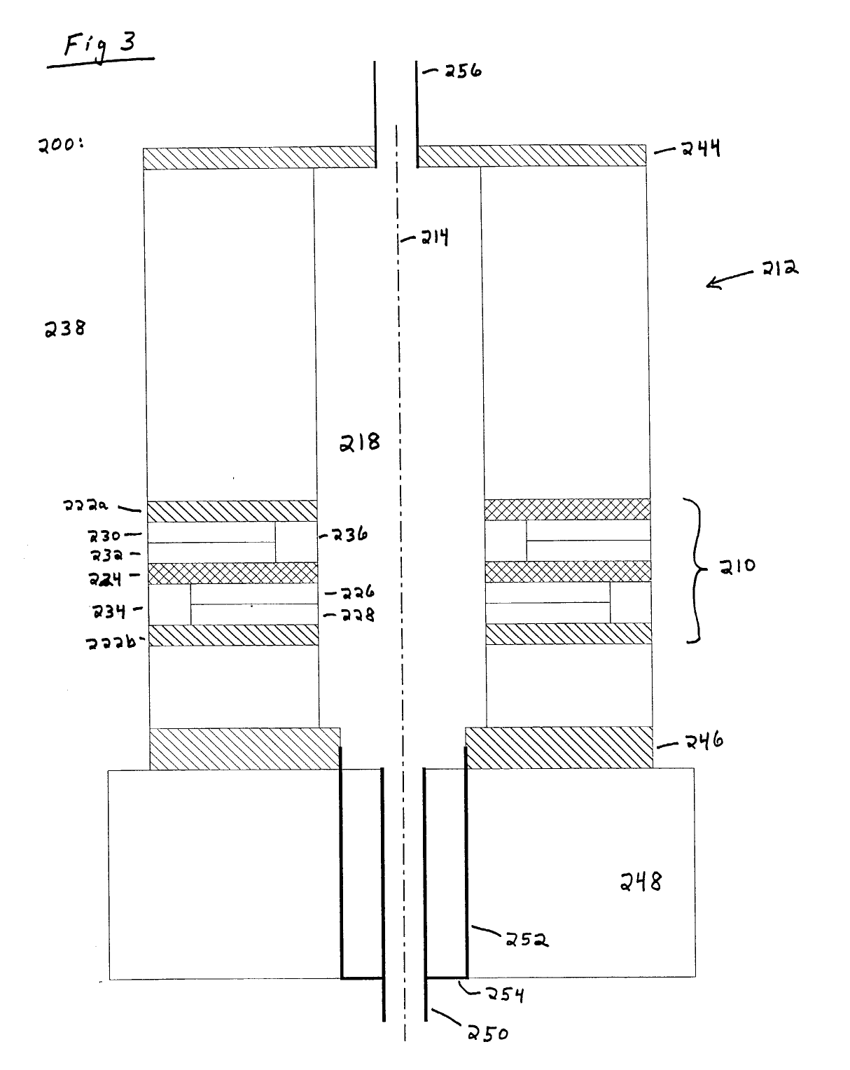

Turning now to FIG. 3, another embodiment of the present invention, a steam electrolyzer, is described and shown at numeral 200. Steam electrolyzer 200 comprises at least one cell 210 arranged in a stack 212. Of course steam electrolyzer 200 is described as having just a single cell for purposes of explanation, however any number of cells 210 may be employed in stack 212. A centerline 214 is shown and an oxygen chamber 238, or hot oxygen manifold, surrounds stack 212 for collecting the oxygen produced by stack 212. Cells 210 surround a hydrogen/steam mixing chamber 218.

Each cell 210 is separated from and electrically connected to adjacent cells by an electronically conductive separator disc 222a, b. Each cell 210 contains a single separator disc 222a, the second separator disc 222b being a separator of an adjacent cell. Within each cell 210 is a solid oxide electrolyte disc 224. A fuel electrode 226 abuts electrolyte disc 224 directly below electrolyte disc 224. A fuel diffusion layer 228 is positioned between fuel electrode 226 and separator disc 222b. An oxygen electrode 232 abuts electrolyte disc 224 directly above electrolyte disc 224. An oxygen flow layer 230 is positioned between oxygen electrode 232 and separator 222a. Both fuel diffusion layer 228 and oxygen flow layer 230 are highly porous. Layer 228 is sufficiently thick so as to allow the hydrogen and steam to diffuse through it with only moderate composition gradients. Layer 230 is sufficiently thick to minimize pressure drop from flowing oxygen. Layers 228 and 230 are also good electrical conductors.

A fuel electrode annular seal 234 surrounds fuel electrode 226 and fuel diffusion layer 228. Seal 234 extends from separator 222b to electrolyte disc 224. The upper end of seal 234 is substantially flush with electrolyte disc 224. The lower end of seal 234 is substantially flush with separator 222b. An oxygen electrode annular seal 236 is located inside oxygen electrode 232 and oxygen flow layer 230. Seal 236 extends from electrolyte disc 224 to separator 222a. The upper end of seal 236 is substantially flush with separator 222a. The lower end of seal 236 is substantially flush with electrolyte disc 224.

Separators 222a and 222b can be made of any material common in the field, such as a high-temperature alloy which forms a thin protective oxide surface layer with good high-temperature electrical conductivity. Electrolyte disc 224 may be of yttria-stabilized zirconia, or any other suitable material. Fuel electrode 226 and fuel diffusion layer 228 can be of, for example, a doped ceria/nickel mixture. Nickel foam may be used for fuel diffusion layer 228 . Oxygen electrode 232 and oxygen flow layer 230 can be of, for example, strontium-doped lanthanum manganite. Seals 234 and 236 can be made from a suitable glass. A thin layer of ink, such as an ink made from a finely-divided electrode composition, may be applied on each side of separators 222a, b. Ink is applied to improve the electrical contact between the components of cell 210.

An exit tube 256 allows the hydrogen/steam mixture to continually exit stack 212. Stack 212 is additionally clamped or situated between a first electrically conductive end plate 244 and a second electrically conductive end plate 246 via a spring-loaded clamping means (not shown) or any other method conventional in the art.

Stack 212 still further includes a thermal insulation 248 at the base of stack 212 and below second end plate 246. A water feed conduit 250 is introduced into stack 212 through the center of stack 212 at its end having thermal insulation 248 and second end plate 246, and is introduced between thermal insulation 248 and second end plate 246 overlying thermal insulation 248. Water feed conduit 250 serves as a conduit for the introduction of water, in either the liquid, vapor, or supercritical fluid state, directly into the center of stack 212. Water feed conduit 250 is sealed by welding to second end plate 246 via a sealing tube 252 and a sealing disc 254. Thermal insulation 248 is also present in the annulus between conduit 250 and tube 252.

Thermal insulation 248 can optionally further include additional insulation (not shown) and thermal insulation 248 serves to insulate the heated stack 212 and water feed conduit 250 during operation. It is noted that fuel electrode 226, fuel diffusion layer 228, oxygen flow layer 230, oxygen electrode 232, and thermal insulation 248 are porous and permit gas to flow through them. The remaining elements in FIG. 3 are substantially impervious to gasflow.

Steam electrolyzer 200 may be contained within an insulated pressure vessel and operated at high pressures, even at pressures above the critical pressure of water. Such high pressure operation can eliminate the need for subsequent compression to yield high pressure hydrogen gas. For high pressure operation, the feed water is fed to tube 250 from a high pressure water pump (not shown).

During operation, water is continually fed through water tube 250, electric current is supplied to stack 212, oxygen is continually withdrawn from chamber 238, and a hydrogen/steam mixture is continually withdrawn through tube 256. Stack 212 is operated with essentially zero pressure difference between chamber 218 and chamber 238 by regulation of the gas exit pressures. The incoming water mixes with the hydrogen steam mixture in mixing chamber 218, resulting in the desired composition, for example about 10 to 20% steam. The preferred composition in chamber 218 contains sufficient steam for good diffusion in fuel diffusion layer 228 and for moderate cell electrolysis EMF but not an excessive amount, which will increase the size of external auxiliary equipment. The feed water may be preheated to any desired temperature before introduction to tube 250.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. It would be evident to one familiar with the art that the cells of the system of the present invention need not be identical. The object of the present invention may be performed with a system not having like cells, or cells of varying thicknesses in a single system or even comprising varying materials in a single system. Accordingly, the present invention is intended to embrace all such alterations, combinations, modifications, and variations that fall within the spirit and scope of the appended claims.

What is claimed is:

1. An electrochemical system adapted to facilitate the direct injection of carbonaceous fuels, said system comprising:
at least one hollow planar cell arranged to form an electrochemical stack, said stack including an electrical contact structure at each end of said stack;
an electronically conductive, substantially impervious to gas, hollow planar separator for separating each cell from an adjacent cell within said stack and electrically connecting each cell to an adjacent cell;
a hollow planar, substantially impervious to gas, electrolyte within each cell;
a hollow planar fuel electrode contacting said electrolyte, said electrode being on one side of the electrolyte;
a hollow planar oxygen electrode contacting said electrolyte and being located on the opposite side of electrolyte from said fuel electrode;
an electronically conductive fuel diffusion layer contacting said fuel electrode, said fuel diffusion layer adapted to allow fuel and oxidized fuel species transport within a fuel gas mixture via gaseous diffusion between the edge of said layer and said fuel electrode;
an electronically conductive oxygen diffusion layer contacting said oxygen electrode, said oxygen diffusion layer adapted to allow oxygen transport within an oxygen-containing gas mixture via gaseous diffusion between the edge of said layer and said oxygen electrode;
a first seal preventing said oxygen-containing gas mixture from accessing said fuel electrode and said fuel diffusion layer;
a second seal preventing said fuel gas mixture from accessing said oxygen electrode and said oxygen diffusion layer;
a fuel chamber communicable with at least one fuel feed conduit, said conduit adapted to introduce a carbonaceous fuel directly into said fuel chamber of said stack; and
at least one fuel exit conduit adapted to permit the exit of partially oxidized fuel mixture from the fuel chamber of said stack.

2. The electrochemical system of claim 1 wherein said system further includes thermal insulation for insulating said at least one fuel feed conduit to prevent the fuel from overheating in the conduit, and thereby preventing the formation of solid deposits in said at least one fuel feed conduit.

3. The electrochemical system of claim 1 wherein said fuel feed conduit is adapted to introduce a carbonaceous fuel that is a gaseous or distillate liquid hydrocarbon.

4. The electrochemical system of claim 1 wherein said fuel electrode is sulfur tolerant.

5. The electrochemical system of claim 1 wherein said fuel electrode and said fuel diffusion layer are the same structure.

6. The electrochemical system of claim 1 wherein said oxygen electrode and said oxygen diffusion layer are the same structure.

7. The electrochemical system of claim 1 wherein said at least one cell has a shape selected from the group consisting of circular, polygonal, and oval.

8. The electrochemical system of claim 1 wherein said at least one hollow planar cell is defined by at least one cavity.

9. The electrochemical system of claim 1 and further including an additional electrical contact layer applied to at least one side of said separator to improve the electrical contact between the components of said at least one cell.

10. The electrochemical system of claim 9 wherein said additional electrical contact layer is an ink comprising a finely divided electrode composition.

11. The electrochemical system of claim 1 wherein said at least one fuel exit conduit comprises an unsealed fuel flow layer within said stack.

12. An electrochemical system adapted to facilitate the direct injection of carbonaceous fuels, said system comprising:
at least one hollow planar cell arranged to form an electrochemical stack, said stack including an electrical contact structure at each end of said stack;
an electronically conductive, substantially impervious to gas, hollow planar separator for separating each cell from an adjacent cell within said stack and electrically connecting each cell to an adjacent cell;
a hollow planar, substantially impervious to gas, electrolyte within each cell;
a hollow planar fuel electrode contacting said electrolyte, said electrode being on one side of the electrolyte;
a hollow planar oxygen electrode contacting said electrolyte and on the opposite side of electrolyte from said fuel electrode;
an electronically conductive fuel diffusion layer contacting said fuel electrode, said fuel diffusion layer adapted to allow fuel and oxidized fuel species transport within a fuel gas mixture via gaseous diffusion between the edge of said layer and said fuel electrode;
an electronically conductive oxygen diffusion layer contacting said oxygen electrode, said oxygen diffusion layer adapted to allow oxygen transport within an oxygen-containing gas mixture via gaseous diffusion between the edge of said layer and said oxygen electrode;
a first seal preventing said oxygen-containing gas mixture from accessing said fuel electrode and said fuel diffusion layer;
a second seal preventing said fuel gas mixture from accessing said oxygen electrode and said oxygen diffusion layer;
a fuel chamber communicable with at least one fuel feed conduit, said conduit adapted to introduce a carbonaceous fuel directly into said fuel chamber of said stack;
at least one fuel exit conduit adapted to permit the exit of oxidized fuel mixture from the fuel chamber of said stack; and
at least one structure comprising a heat resistant material defining a fuel flow passage within said fuel chamber surrounded by said at least one hollow planar cell.

13. The electrochemical system of claim 12 wherein said system further includes thermal insulation for insulating said at least one fuel feed conduit to prevent the fuel from overheating in the conduit, and thereby preventing the formation of solid deposits in said fuel feed conduit.

14. The-electrochemical system of claim 12 wherein said fuel chamber is adapted to receive carbonaceous fuel that is a gaseous or liquid hydrocarbon.

15. The electrochemical system of claim 12 wherein said at least one cell has a shape selected from the group consisting of circular, polygonal, and oval.

16. The electrochemical system of claim 12 wherein said fuel electrode is sulfur tolerant.

17. The electrochemical system of claim 12 wherein said fuel electrode and said fuel diffusion layer are the same structure.

18. The electrochemical system of claim 12 wherein said oxygen electrode and said oxygen diffusion layer are the same structure.

19. The electrochemical system of claim 12 wherein said at least one hollow planar cell is defined by at least one cavity.

20. The electrochemical system of claim 12 and further including an additional electrical contact layer applied to at least one side of said separator to improve the electrical contact between the components of said at least one cell.

21. The electrochemical system of claim 20 wherein said additional electrical contact layer is an ink comprising a finely divided electrode composition.

22. The electrochemical system of claim 12 wherein said at least one fuel exit conduit comprises an unsealed fuel flow layer within said stack.

23. A steam electrolyzer adapted to facilitate the direct injection of water or steam, said system comprising:
at least one hollow planar cell arranged to form an electrochemical stack, said stack including an electrical contact structure at each end of said stack;
an electronically conductive, substantially impervious to gas, hollow planar separator for separating each cell from an adjacent cell within said stack and electrically connecting each cell to an adjacent cell;
a hollow planar, substantially impervious to gas, electrolyte within each cell;
a hollow planar fuel electrode contacting said electrolyte, said electrode being on one side of the electrolyte;
a hollow planar oxygen electrode contacting said electrolyte and being located on the opposite side of said electrolyte from said fuel electrode;
an electronically conductive fuel diffusion layer contacting said fuel electrode, said fuel diffusion layer adapted to allow hydrogen and steam transport within a hydrogen/steam mixture via gaseous diffusion between the edge of said layer and said fuel electrode;
an electronically conductive oxygen flow layer contacting said oxygen electrode, said oxygen flow layer adapted to allow oxygen transport via pressure difference between the edge of said layer and said oxygen electrode;
a first seal preventing said oxygen from accessing said fuel electrode and said fuel diffusion layer;
a second seal preventing said hydrogen/steam mixture from accessing said oxygen electrode and said oxygen diffusion layer;
at least one water feed conduit adapted to introduce liquid or gaseous water directly into a hydrogen/steam chamber of said stack; and
at least one exit conduit adapted to permit the exit of wet hydrogen from the hydrogen/steam chamber of said stack.

24. The steam electrolyzer of claim 23 wherein said system further includes thermal insulation for insulating said at least one water feed conduit to prevent liquid water from overheating in the conduit, and thereby causing pressure pulsations.

25. The electrochemical system of claim 23 wherein said fuel electrode and said fuel diffusion layer are the same structure.

26. The electrochemical system of claim 23 wherein said oxygen electrode and said oxygen diffusion layer are the same structure.

27. The steam electrolyzer of claim 23 wherein said at least one cell has a shape selected from the group consisting of circular, polygonal, and oval.

28. The steam electrolyzer of claim 23 wherein said at least one hollow planar cell is defined by at least one cavity.

29. The steam electrolyzer of claim 23 and further including an additional electrical contact layer applied to at least one side of said separator to improve the electrical contact between the components of said at least one cell.

30. The steam electrolyzer of claim 29 wherein said additional electrical contact layer is an ink comprising a finely divided electrode composition.
